(19) United States
(12) Patent Application Publication
(10) Pub. No.: US 2005/0257343 A1
(43) Pub. Date: Nov. 24, 2005

(54) Self-contained hinge for flip-style device

(75) Inventor: Sheel A. Gupte, Buffalo Grove, IL (US)

Correspondence Address: GREER, BURNS & CRAIN, 300 S WACKER DR, 25TH FLOOR, CHICAGO, IL, 60606, US

(73) Assignee: Amphenol-T&M Antennas

(21) Appl. No.: 11/180,204

(22) Filed: Jul. 13, 2005

Related U.S. Application Data
(63) Continuation-in-part of application No. 10/427,682, filed on Apr. 30, 2003.
(60) Provisional application No. 60/400,831, filed on Aug. 2, 2002.

(51) Int. Cl. E05D 11/10

(52) U.S. Cl. 16/330

(57) ABSTRACT

A self-contained hinge is disclosed for use in a flip-style device, such as a personal digital assistant (PDA). A can receives a spring that provides a compressive force to maintain a cam pressed against a follower. Additionally, the spring applies a torsional force to the cam to facilitate rotation of the follower relative to the cam and automatically open the hinge.

### CROSS-REFERENCE TO RELATED APPLICATIONS

This application is a continuation-in-part of prior application Ser. No. 10/427,682, filed Apr. 30, 2003, which claims the benefit of U.S. Provisional Application Ser. No. 60/400,831, filed Aug. 2, 2002, now abandoned.

### FIELD OF THE INVENTION

The field of the invention is flip-style devices, for example personal digital assistants (PDA's) and cell phones. More particularly, the invention relates to hinges for such flip-style devices.

### BACKGROUND OF THE INVENTION

Due to size and aesthetics, flip-style housings are popular for a wide range of small portable devices, such as PDA's and wireless devices, e.g., cell phones. A flip-style device generally requires a hinge connecting a main part and a flip part of the device. Commonly, it is desirable for the hinge to provide initial resistance to movement of the flip part from either a fully open or a fully closed position of the flip-style device. It is also desirable that the hinge assists a user in reaching the completion of a movement of the flip part toward the fully open or the fully closed positions. This is especially desirable when the flip part is partially rotated toward the fully open position at an angle of 15 degrees or greater from the fully closed position. However, known flip-style devices have flip parts that assist with rotation when the flip part is partially rotated toward the fully open position at angles of 45 degrees or greater from the fully closed position.

Cost, simplicity, ease of assembly and small size are omnipresent concerns in the design and manufacture of hinges for flip-style devices. Another concern is assisting a user to open a flip part of a flip-style device at angles lower than 45 degrees from the fully closed position. A further concern is the ability to separately manufacture the hinges as self-contained units that can be readily assembled to other components of flip-style devices.

### SUMMARY OF THE INVENTION

A self-contained hinge having a can and a spring providing both torsional and compressive force is disclosed for use in any flip-style device. The hinge also has a cam that can be positioned within the can and receives an elongated shaft connected to a follower therethrough. The spring is rotationally held relative to the cam and the elongated shaft and compresses the cam and the follower together. Additionally, the spring applies a torsional force to the cam and follower.

### BRIEF DESCRIPTION OF THE DRAWINGS

Other features, objects and advantages will be apparent to those skilled in the art through reference to the detailed description and the drawings, of which:

FIG. 1 is a perspective view of a self-contained hinge in accordance with a preferred embodiment of the present invention;

FIG. 2 is a side view of a back side of the cam of FIG. 1;

FIG. 3 is a perspective view of an exemplary flip-style device in a fully closed position;

FIG. 4 is a perspective view of the flip-style device of FIG. 3 in a fully open position;

FIG. 5 is an exploded view of a self-contained hinge in accordance with a second preferred embodiment of the present invention;

FIG. 6 is an alternate exploded view of the self-contained hinge of FIG. 5;

FIG. 7A is a partial perspective view of the follower of the self-contained hinge of FIG. 5;

FIG. 7B is a perspective view of the cam of the self-contained hinge of FIG. 5;

FIG. 8 is a perspective view of an assembled self-contained hinge in accordance with a third preferred embodiment of the present invention;

FIG. 9 is an exploded view of the self-contained hinge of FIG. 8;

FIG. 10 is a plan view of the self-contained hinge of FIG. 8;

FIG. 11 is a side view of the self-contained hinge of FIG. 8;

FIG. 12 is a perspective view of an underside of the self-contained hinge of FIG. 8; and

FIG. 13 is a sectional view along lines 13-13 of FIG. 8.

### DETAILED DESCRIPTION OF THE PREFERRED EMBODIMENTS

The invention is directed to a self-contained hinge having a follower and an elongated shaft configured to accept a cam on the elongated shaft. A spring provides compressive force to hold the cam against a surface of the follower and also provides torsional force to regulate relative rotational movement between the cam and the follower. In preferred embodiments, the cam and spring are configured to provide a self-opening and self-closing force after initial resistance to opening from a fully closed position and initial resistance to closing from a fully open position. To further illustrate these preferred broader aspects of the invention, preferred embodiments of the invention that include additional inventive features will now be discussed with reference to the drawings.

In general, PDA's and the like have a flip part and a main part that are connected to each other by a hinge. The hinge is often inserted through one of the parts, and then connected to the other part. Depending on the design construction, either the flip part or the main part may be formed to initially receive the hinge. The hinge regulates controlled movement between the flip part and the controlled part. In this manner, the flip-style device may be rotated from an open position to a closed position (i.e., an open-to-shut cycle) or vice-versa (i.e., a shut-to-open cycle). The hinge should also provide an initial resistance to rotation when the flip-style device is in the fully open position or the fully closed position.

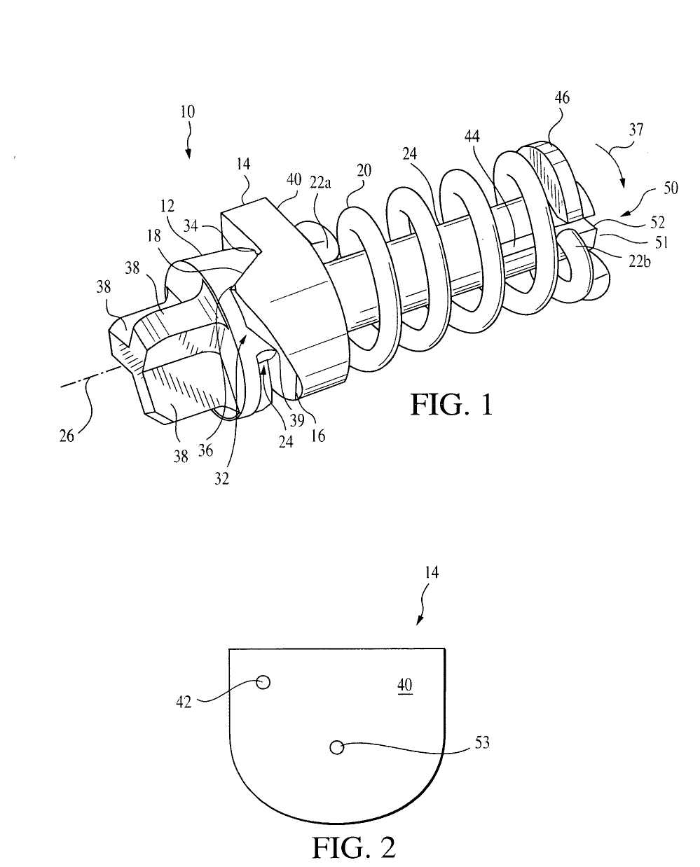

Turning now to the drawings, FIG. 1 illustrates a preferred embodiment self-contained hinge, generally designated 10. A follower 12 cooperates with a cam 14 that is axially aligned with and rides on the follower 12 such that a surface 16 of the cam mates with a follower surface 18 of the follower 12 under the influence of a compressive force supplied by a spring 20. The spring 20 also provides torsional forces to help regulate relative rotational movement between the follower 12 and the cam 14 and provide self-opening assistance. The spring 20 has an end 22a connected to the cam 14 such that the end 22a and the cam 14 rotate together. Another end 22b of the spring connects to an elongated shaft 24 of the follower 12 in a manner such that they rotate together. In other words, the spring 20 is rotationally held relative to the cam 14 and the follower 12. It is preferred that the spring 20 is rotationally fixed relative to both the cam 14 and the follower 12, but in no case may the spring 20 freely rotate with respect to either the cam 14 or the follower 12. The spring 20 may accordingly apply both torsional and compressive forces to the cam 14 and the follower 12 to effect relative rotation of the cam 14 to the follower 12 during the open-to-shut and shut-to-open cycles of a flip-style device. Advantageously, the hinge 10 is self-contained, i.e., it can be fully assembled and later incorporated into a flip-style housing of a flip-style device. Additionally, a container or can may be included to house the follower 12, cam 14, spring 20, and any other components of the hinge 10.

The formation of the hinge 10 as a self-contained unit that may be manufactured independently of other components of a flip-style device is a desirable feature of the hinge. This feature is advantageous because it allows manufacturers of flip-style devices to incorporate outside vendor's hinges in their devices. Additionally, these hinges can function in an entire flip-style product line to minimize a manufacturer's inventory of parts, and may be mass produced to reduce costs and be assembled with different manufacturers' products.

The cam 14 is rotatably and slidably coupled about the elongated shaft 24 to enable relative rotation of the follower 12 and the cam 14 about a longitudinal axis 26 and to allow the cam 14 limited axial movement along the elongated shaft 24. The cam 14 mechanically communicates with the follower 12. In general, the cam 14 and the follower 12 are shaped to rotate between defined positions, e.g., the fully open and the fully closed positions of the flip-style device. FIG. 1 illustrates the follower 12 rotated about the cam 14 to a cam closed position wherein the torsional force applied by the spring 20 is at a maximum, but insufficient to overcome the holding position supplied by a cam and follower interface 32, and in particular a ridge 34 of the follower 12 that is held against a peak 36 of the cam 14 in the closed position. At the cam closed position, the follower 12 can rotate relative to the cam 14 about the longitudinal axis 26 in a direction 37 when sufficient external force is provided.

The ridge 34 and peak 36 are configured to hold the cam 14 and follower 12 in the closed position of FIG. 1 by opposing the rotation force applied by the spring 20. An external force, e.g., as provided by a user of a flip-style device including the hinge 10 is necessary to move the hinge from the FIG. 1 closed position. The follower 12 has a device interface formed by three radially extending members 38 that can secure one end of the hinge 10 to a flip-style device.

The profile of the cam and follower interface 32 provides an initial resistance to rotation of the follower 12 in the direction of the arrow 37 upon application of an external rotational force. After overcoming the peak 36, the spring 20 automatically rotates the follower 12 to another ridge 39 that cooperates with the cam surface 16 and prevents further rotation of the follower 12. This defines a fully open position. The ridges 34, 39 define a profile or line of contact between the follower 12 and the cam 14. The specific design of the profile varies according to several factors, such as the dimensions of the cam 14 and the follower 12, and facilitates reduced contact stresses on the cam 14 and the follower 12 to limit wear and tear of these components. The profile of the cam and follower interface 32 further determines the angular position of the follower 12 relative to the cam 14 at which self-opening occurs. Preferably, the ridge 34 is designed to override the peak 36 of the cam 14 at about 15 degrees of relative cam/follower rotation from the FIG. 1 closed position. At this override point, the spring forces applied by the spring 20 will be independently sufficient to move the follower 12 relative the cam 14 until the ridge 39 is encountered. Thus, the spring 20 preferably applies an opening torque from the cam closed position that advantageously acts between 10 degrees and 165 degrees of relative rotation between the follower 12 and the cam 14.

The self-opening movement of the hinge 10 is primarily attributable to the rotational force of the spring 20. However, the compressive force will also assist rotation while the peak 36 rides down the ridge 34. The rotational force of the spring 20 will hold the follower 12 against the ridge 39, thereby holding the hinge 10 in an open position until a sufficient external force is applied to reverse movement back over the ridge 34 into the FIG. 1 position. During closing, once the peak 36 passes the ridge 34, compressive force of the spring 20 may provide some self-closing assistance. This will depend, however, on the relative amount of torsional force that opposes movement back to the fully closed FIG. 1 position. Preferably, the spring 20 applies a closing torque from the cam closed position that acts between 0 and 10 degrees of relative rotation between the follower 12 and the cam 14.

The detailed torque behavior of the cam 14 can be controlled by controlling the spring torque, spring compression and profile of the cam and follower interface 32. As will be appreciated by those skilled in the art, there are various parameters that have to be taken into consideration when determining the torsional and compressive properties of the combination of the spring 20, cam 14, and follower 12. These parameters include, for example, the profile of the cam 14, the initial torque required to begin rotation, the flip over angle, the angular range of rotation, the end torque required to complete rotation, and the flip over torque.

Compressive and rotational spring forces also effect the hinge “feel” in use, namely the resistance to opening and closing and the amount of self-opening force. These may be tailored to suit particular uses, for example by using different locations to secure the ends 22a, 22b of the spring 20.

The compression force “k” provided by the spring 20 must be sufficient to permit the cam and follower interface 32 to hold the closed position in opposition to the torsional force supplied by the spring 20. In other words, the torque attributable to the compressive force at the cam and follower interface 32 must exceed the torsional force of the spring 20 in the fully closed position by a certain value. This value determines the closing bias torque. For example, if a +35N-mm torque is desired on the closed position and the torsion spring gives −30N-mm torque at the closed position, then the cam and follower interface 32 and the force of compression should be such that it provides an initial torque of +65N-mm. A relatively low limit for the compression value ‘k’ for a spring 20 when it is also designed to function as a torsional spring requires a correspondingly steep interface to be provided by the ridge 34 and peak 36.

A back side 40 of the cam 14 is illustrated in FIG. 2. The preferred helical spring 20 encircles the elongated shaft 24 and has the axially parallel end 22a (relative to the longitudinal axis 26) inserted into a hole 42 of the back side 40 of the cam 14 to fix the spring 20 to the cam 14. The spring 20 has its other radially extending end 22b inserted into a longitudinal slot 44 of the follower 12 (FIG. 1). The hole 42 is preferably formed of a size and diameter to provide a close frictional fit. The slot 44 limits substantial movement of the end 22b to the longitudinal direction, permitting compression of the spring 20 during assembly. A retaining member, such as a C-clip or helical washer 46, which is attached to the elongated shaft 24 holds the spring 20 on the elongated shaft 24 and provides resistance to allow the spring 20 to exert the compressive force on the cam 14.

The preferred helical washer 46 prevents distortion of the spring 20 once the hinge 10 is assembled, and additionally may provide structural support to the hinge 10 upon insertion into a flip-style device. The helical washer 46 is positioned to minimize distortion of the spring 20 toward an end 50 of the elongated shaft 24. The end 50 includes a formation 51 to hold the washer 46. The formation 51 encircles only a portion of the circumference of the elongated shaft 24, permitting a gap 52 in the washer 46 to pass over the formation. The washer 46 is then turned slightly during assembly so that it abuts the formation 51. Alternative retaining members, e.g., cotter pins, may also be used in the present hinge 10 to assist with the compressing of the spring 20 against the cam 14 and/or preventing spring distortion.

As seen in FIG. 2, the cam 14 has an opening 53 that receives the elongated shaft 24 therethrough. The opening 53 and elongated shaft 24 are preferably smooth to reduce friction that would affect relative rotation and axial movement between the cam 14 and the follower 12. The opening 53 is preferably dimensioned, however, closely to the shaft 24 so that there is no significant radial movement of the cam 14.

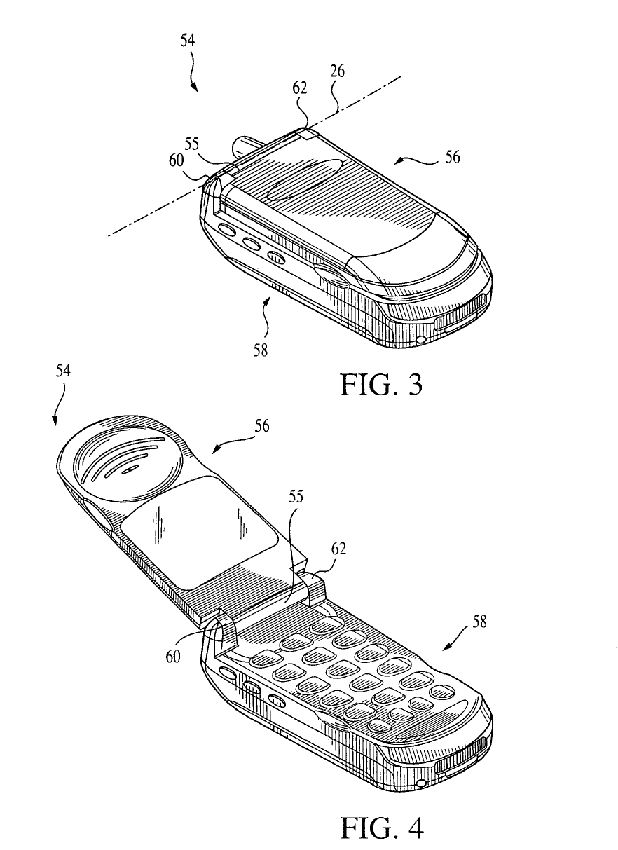

FIG. 3 shows a flip-style device, namely a cell phone 54 that incorporates the present hinge 10 of FIG. 1. Preferably, a hinge 10 is held at one of opposite ends of a hinge enclosure portion 55 of a flip part 56. It may also be desirable to have a hinge 10 at both ends of the enclosure portion 55, with two hinges acting cooperatively to control opening and closing of the flip part 56. The device interfaces of the hinges, e.g., radially extending members 38 lock into a pair of hinge holding ends 60, 62. Because the spring 20 and helical washer 46 may be compressed toward the cam 14, a fully assembled hinge 10 is easily inserted into the hinge enclosure portion 55. The spring 20 is compressed to permit joining of the flip part 56 and main part 58. Generally, the cell phone 54 is formed of two main components, a flip part 56 and a main part 58. The flip part 56 and the main part 58 rotate relative to one another about the longitudinal axis 26 of a hinge 10 held in the enclosure portion 55. The flip part 56 experiences a torsional force provided by internal components of the hinge 10, and automatically rotates to the fully open position upon a predetermined angle of rotation of the flip part about the longitudinal axis 26. The amount of torsional force applied by the internal components of the hinge 10 may be designed according to the dimensions and weight of the flip part 56.

FIG. 4 shows the cell phone 54 in a fully open position. The hinge 10 is at the open angle limit and maintains the flip part 56 in the fully open position.

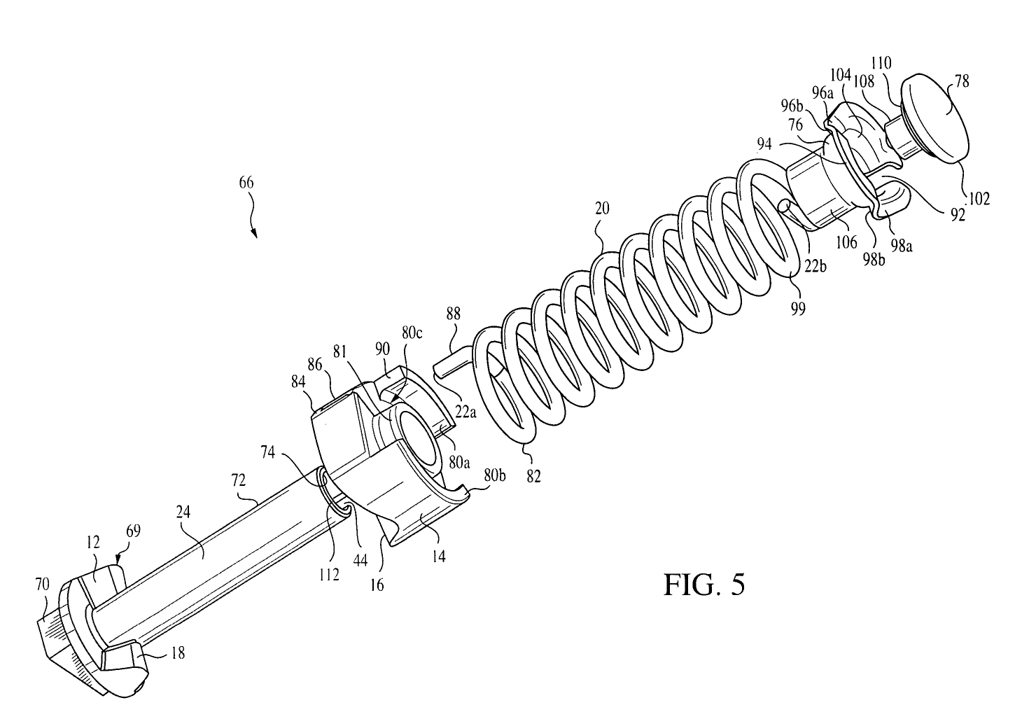

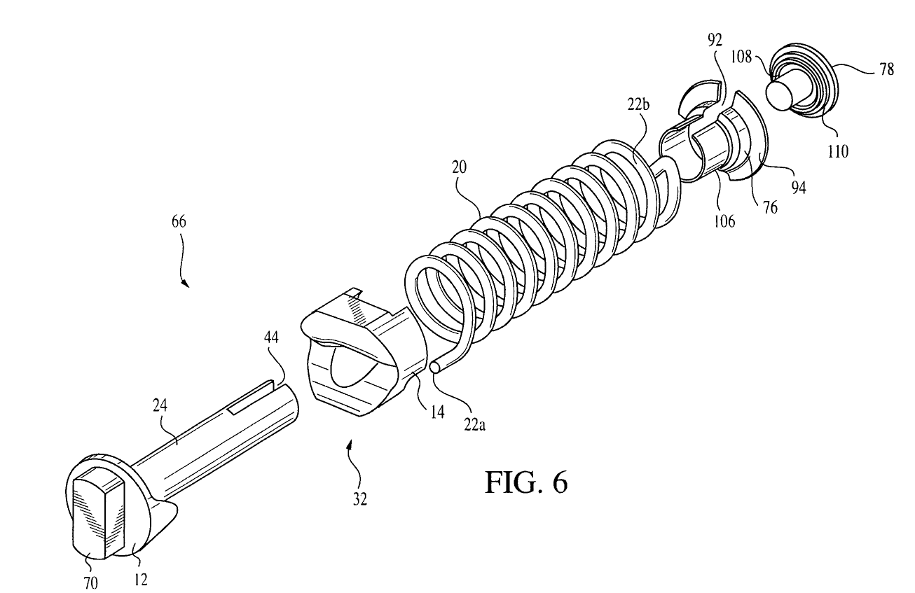

A second preferred embodiment of a self-contained hinge, generally designated 66, is illustrated in FIGS. 5-6 and has like components identified with identical reference numerals as used in FIG. 1. In the hinge 66, a device interface is formed by a single extending member 70 for engagement with a complimentary main part or flip part of a cell phone. The elongated shaft 24 of the follower 12 is generally hollow. It therefore defines an outer surface 72 and an inner surface 74, which serves to engage a retaining member formed by a collar 76 and a cap 78.

The cam 14 of the hinge 66 includes a pair of opposing seats 80a and 80b and a shaped seating area 80c that receive a first end turn 82 of the spring 20 upon assembly of the hinge 66. A cylindrical extension 81 extends within the spring 20 and fixes its position in the seating area 80c. An outer surface 84 of the cam 14 has a groove 86 to receive the end 22a of the spring 20. An end 88 of the spring 20 is also received by the groove 86 and further engages an end 90 of the seat 80a.

The collar 76 has a slot 92 extending through its entire length to accept the end 22b of the spring 20. The spring 20 is compressed by a flange 94. The flange 94 includes valleys 96a and 98a that create spring contact surfaces 96b and 98b. The valley 98a is deeper than the valley 96a, thus extending the surface 98b further toward the cam 14 than the surface 96b. This serves the same purpose as the helical shape of the preferred FIG. 1 washer 46, with the respective surfaces 96b and 98b pressing against different points of a second end turn 99 of the spring 20.

The cap 78 includes an outer rim 102 that seats on a ledge 104 of the collar 76. The interior diameter of the collar 76 is slightly larger than the elongated shaft 24 so a sleeve 106 slides over the outer surface 72. A cylinder 108 of the cap 78 slides within the elongated shaft 24 along its inner surface 74. A female snap fit formation 110 on the cap 78 snap fits to a male snap fit formation 112 on the shaft 24. When the snap fit is complete, the collar 76 is held by the outer rim 102. The flange 94 may be pressed by a flip-style device portion to permit the spring 20 to compress, thereby allowing the flange 94 and device interface 70 to move closer relative to one another to permit assembly into a flip-style device. The end 22b of the spring may move within the slot 92 during assembly.

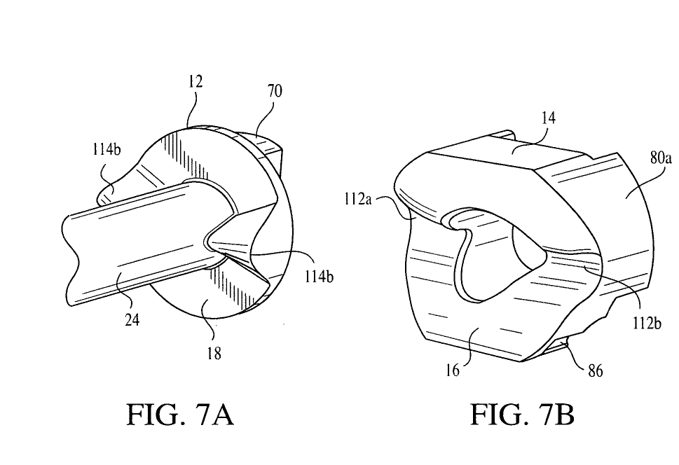

FIGS. 7A and 7B illustrate the cam surface 16 of the cam 14 and the follower surface 18 of the follower 12. The cam surface 16 mates with the follower surface 18 to form the cam and follower interface 32. The cam surface 16 has a profile defined by valleys 112a and 112b. These valleys 112a and 112b are engaged by peaks 114a and 114b of the follower 12 as the cam 14 rotates relative to the follower 12 between the fully open and fully closed positions of the hinge 66. As discussed with reference to the hinge 10 of FIG. 1, the specific design of the profile varies according to several factors and facilitates reduced contact stresses on the cam 14 and the follower 12 to limit wear and tear of these components.

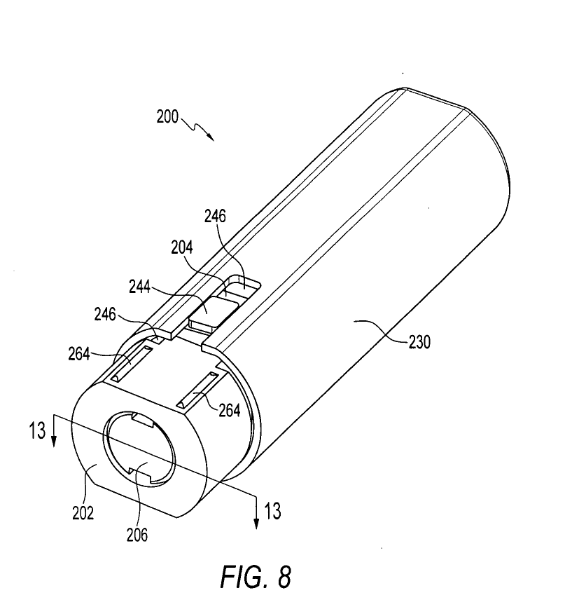

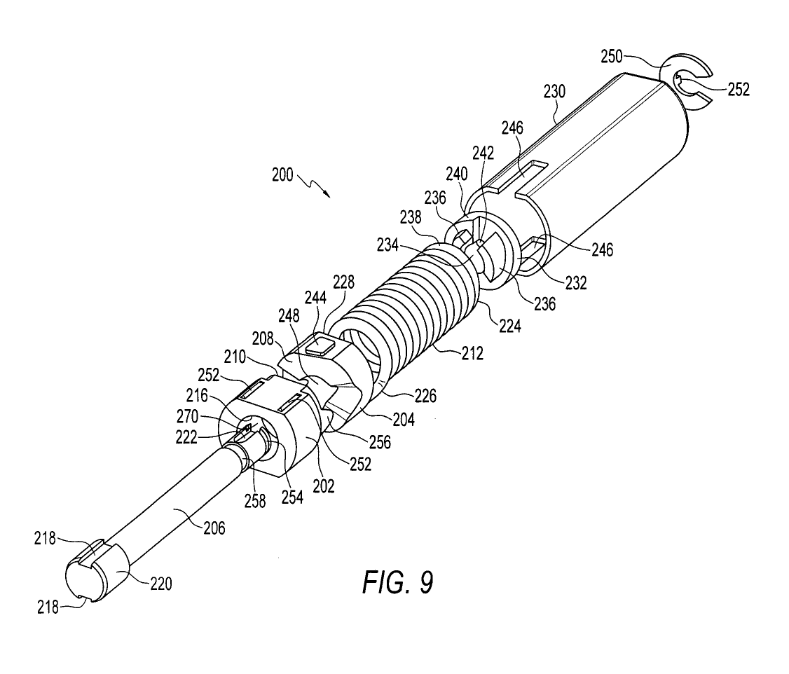

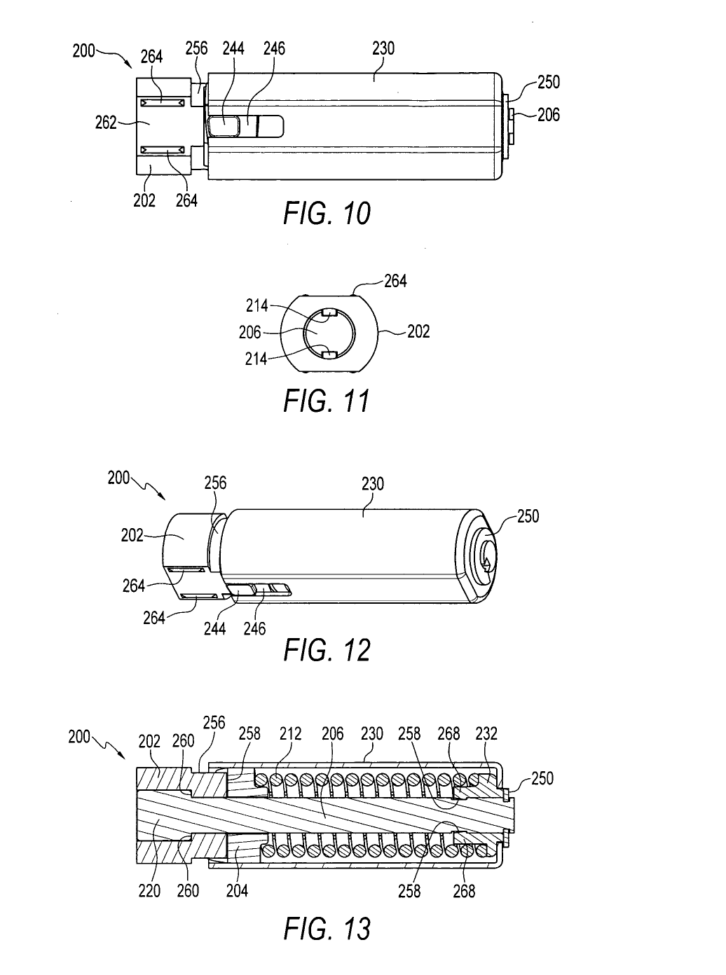

A third preferred embodiment of a self-contained hinge, generally designated 200, is shown in FIGS. 8-13. FIG. 8 shows the hinge 200 assembled, and FIG. 9 shows an exploded view of the hinge. FIGS. 10-12 show plan, side, and underside perspective views of the hinge 200, respectively. Similar to the self-contained hinge 10, the present hinge 200 has a follower 202 that cooperates with a cam 204 that is axially aligned with and rides on an elongated follower shaft 206 such that a surface 208 of the cam meets with a follower surface 210 of the follower 202 under the influence of a compressive force applied by a spring 212. The operation of the follower 202, cam 204, and spring 212 is similar to the operation of these components with the previous hinges 10 and 66, and will therefore not be repeated for brevity. Moreover, it is envisioned that features of the previously described hinges 10 and 66 can be implemented with the present hinge 200 and vice-versa, as suits the particular hinge application.

A feature of the present hinge 200 is that the follower 202 and the elongated shaft 206 are separate components. Accordingly, the hinge 200 can be readily assembled and/or disassembled at either end of the elongated shaft 206. In particular, the present follower 202 has a pair of tabs 214 (FIG. 11) formed on an inner surface 216 of the follower 202 that engage slots 218 of a head 220 of the elongated shaft 206 to prevent relative rotation between the elongated shaft 206 and the follower 202. Upon connection of the follower 202 and the elongated shaft 206 together, these components operate similar to the previous embodiment follower 12. For example, the elongated shaft 206 includes a longitudinal slot 222 configured for receiving a first end 224 of the spring 212. The other or second end 226 of the spring 212 is within an opening (not shown) on a back side 228 of the cam 204 like the spring 20 to fix the spring 212 to the cam 204. The cam 204 and follower 202 are configured to rotate relative to one another. The spring 212 has the end 226 rotating with the cam 204 and the other end 224 connecting to the elongated shaft 206 and rotating with the follower 202. Thus, rotation of the follower 202 relative to the cam 204 varies the torsional force applied by the spring 212 to these components since the spring 212 is rotationally held relative to the cam 204 and the follower 202. That is, the spring 212 as a whole does not freely rotate with respect to either the cam 204 or the follower 202. Therefore, the spring 212 may accordingly apply both torsional and compressive forces to the cam 204 and the follower 202 to affect relative rotation of the cam 204 to the follower 202 during the open-to-shut and shut-to-open cycles of a flip-style device. Preferably, the spring 212 applies a torque in the range of 10 to 40 N-mm. However, it is envisioned that the torque may be outside the preferred range for certain hinge designs.

Advantageously, the present hinge 200 is self-contained and includes a can 230 that encloses the cam 204, spring 212 and a cap 232. It is envisioned that the can 230 can be formed of various materials including, but not limited to, plastics, metals, and other materials known to those skilled in the art of hinge design. It is further desirable that the can 230 is contoured to fit within a flip-style device, such as the cell phone 54 shown in FIGS. 3 and 4. Preferably, the can 230 is formed such that the cam 204 can be slidably positioned within the can 230 upon assembly of the hinge 200. Moreover, the can 230 is contoured to permit rotation of the spring 212 and the cap 232 within the can 230.

The cap 232 has an opening 234 for receiving the elongated shaft 206 therethrough, and one or more flanges 236 for receiving an end part 238 of the spring 212. Advantageously, the cap 232 has a helically shaped outer rim 240 to match and prevent the spring 212 from buckling or distorting when the spring 212 is compressed. A slit 242 is provided to enable the end 224 of the spring 212, which is seated on the flanges 236 and rim 240, to engage the longitudinal slot 222 of the follower 206. Thus, upon assembly of the hinge 200, the cap 232 rotates with the follower 202, elongated shaft 206, and the end 224 of the spring 212.

The cam 204 has a pair of protrusions 244 that engage slots 246 in the can 230 when the hinge 200 is assembled. Accordingly, the cam 204 is fixed relative to the can 230, and rotates therewith. While the present embodiment illustrates a cam 204 having a pair of protrusions 244, it is envisioned that one or more protrusions could be used, or alternatively that the cam 204 and the can 230 could be formed so as to prevent rotation of the cam 204 relative to the can 206. The cam 204 also has an opening 248 configured for receiving the elongated shaft 206 therethrough.

The hinge 200 further includes a retaining member, such as E-clip 250, which includes a tab formation 252. Upon assembly of the hinge 200, the E-clip 250 engages a generally annular groove 254 of the elongated shaft 206 such that the tab formation 252 is seated in the longitudinal slot 222 of the elongated shaft 206. Thus, the E-clip 250 is fixed to the elongated shaft 206 and rotates therewith. Upon attachment of the E-clip 250 to the elongated shaft 206, the elongated shaft 206 is prevented from disengaging from the follower 202. Thus, the compressive force of the spring 212 is maintained when the hinge 200 is assembled. Furthermore, while the E-clip 250 is shown generally adjacent to the can 230 upon assembly of the hinge 200, it is envisioned that the E-clip 250 need not contact the can 230 upon assembly of the hinge 200.

Turning now to FIG. 13, a cross sectional view of the hinge 200 along lines 13-13 of FIG. 8 is shown. The follower 202 has an inner radial area 256 that is capable of being positioned within the can 230 such that the follower 202 can rotate within the can 230. In this manner, opening and closing of the hinge 200 can occur upon rotation of the follower 202 relative to the cam 204 at a cam/follower interface 258. The follower 202 also has shoulders 260 formed on the inner surface 216 which engage the head 220 of the elongated shaft 206 to limit movement of the elongated shaft 206 through the follower 202 and toward the cam 204 when the hinge 200 is assembled. Accordingly, the spring 212 can be provided with a sufficient number of coils such that when it is locked into place between the cam 204 and the E-clip 250, the spring 212 provides both torsional and compressive forces to the cam/follower interface 258. In particular, the angle at which the shut-to-open cycle automatically opens can be as low as about 15° from the shut position of a flip-style device.

In addition to the above features, the hinge 200 also has a couple of additional features that limit movement of the components of the hinge 200 relative to each other and/or a knuckle or hinge holding end of a cell phone, such as the ends 60 and 62 shown in FIG. 4. More specifically, another feature of the present hinge 200 is that the follower 202 has an outer surface 262 having crushed ribs 264 thereon to provide an improved frictional fit between the follower 202 and the knuckle of a cell phone. Additionally, the elongated shaft 206 includes a female snap fit formation or groove 266 that receives a male snap fit formation 268 of the cap 232. The male snap fit formation 268 locks into the female snap fit formation 266 to prevent the cap 232 from moving toward or away from the head 220 of the elongated shaft 206 (i.e., in an axial direction along the longitudinal length of the elongated shaft 206) when positioned in an opening of the follower 202. Thus, when the E-clip 250 and the male snap fit formation 268 both engage the elongated shaft 206, as shown in FIG. 13, the cap 232, cam 204, and spring 212 are positioned within the can 230 and subject to the compressive and torsional forces of the spring 212.

While specific embodiments of the present invention have been shown and others described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A self-contained hinge for a flip-style device comprising:
a can having at least one slot;
a cam having an opening and positioned within said can, said cam provided with a protrusion engaging said slot to rotationally fix said cam with respect to said can;
a follower engaging said cam at a cam/follower interface such that said follower rotates relative to said cam, said follower having a through hole defining an inner surface;
an elongated shaft having both a head engaging said inner surface of said follower to rotationally fix said elongated shaft with respect to said follower and an opposing end, said elongated shaft passing through said opening of said cam;
a cap within said can and engaged with said elongated shaft;
a spring having a first end part engaging said elongated shaft and a second end part engaging said cam to compress said cam and said follower together and apply a torsional force to regulate relative movement of said cam and said follower, said first end part of said spring being seated on said cap to prevent distortion of said spring; and
a retaining member fixed to said opposing end of said elongated shaft to prevent axial movement of said elongated shaft and said follower relative to said can.

2. The hinge of claim 1, wherein said cap receives said elongated shaft therethrough.

3. The hinge of claim 1, wherein said elongated shaft includes a longitudinal slot for receiving said first end part of said spring.

4. The hinge of claim 1, wherein said inner surface of said follower has shoulders engaging with said head of said elongated shaft.

5. The hinge of claim 1, wherein said can includes two slots opposed to one another and said cam has two protrusions each engaging with a respective slot of said can.

6. The hinge of claim 1, wherein said retaining member has a tab formation for engaging said longitudinal slot to rotationally fix said retaining member with respect to said elongated shaft.

7. The hinge of claim 6, wherein said retaining member is an E-clip.

8. The hinge of claim 1, wherein said cap has a helically-shaped outer rim to match said spring.

9. The hinge of claim 8, wherein said cap includes one or more flanges extending from said outer rim to seat said first end part of said spring.

10. The hinge of claim 9, wherein said flanges form a slit in said cap such that said spring engages with said elongated shaft via said slit.

11. The hinge of claim 1, wherein said follower includes an inner radial area rotating within said can when said follower rotates with respect to said cam.

12. The hinge of claim 1, wherein said can includes one or more longitudinal slots.

13. The hinge of claim 12, wherein said cam includes an outer surface provided with one or more protrusions, each of said protrusions engaging with one of said longitudinal slots of said can to rotationally fix said cam with respect to said can.

14. The hinge of claim 1, wherein an outer surface of said follower has a plurality of crush ribs.

15. The hinge of claim 1, wherein said inner surface of said follower includes one or more protrusions for engaging slits in said head of said elongated shaft to rotationally fix said follower with respect to said elongated shaft.

16. The hinge of claim 1, wherein said cap includes a male snap fit formation engaging a female snap fit formation of said elongated shaft to prevent axial movement of said cap with respect to said elongated shaft.

17. A self-contained hinge for a flip-style device, comprising:
a can;
a cam with an opening positioned within said can and rotationally fixed with respect to said can;
a follower having a surface engaging said cam, said follower rotating with respect to said cam;
an elongated shaft extending away from said follower surface and through said cam;
a cap within said can and engaged with said elongated shaft;
a spring having a first end part engaging said elongated shaft and a second end part engaging said cam such that said first end part is rotationally fixed with respect to said elongated shaft and said second end part is rotationally fixed with respect to said cam, said first end part of said spring being seated on said cap to prevent distortion of said spring; and
a retaining member fixed to an opposing end of said elongated shaft to prevent axial movement of said elongated shaft and said follower relative to said can.

18. The hinge of claim 17, wherein a head of said elongated shaft opposite to said opposing end has at least one slot engaging with an inner surface of said follower to rotationally fix said follower with respect to said elongated shaft.

19. The hinge of claim 17, wherein said retaining member has a tab formation for engaging a longitudinal slot of said elongated shaft and rotationally fixing said retaining member with respect to said elongated shaft.

20. The hinge of claim 18, wherein said cap has a male snap fit formation and said elongated shaft includes a female snap fit formation, said male snap fit formation engaging with said female snap fit formation to prevent said axial movement of said cap.

21. A self-contained hinge for a flip-style device comprising:
a can having one or more slots;
a cam within said can and having one or more protrusions engaging corresponding slots of said can, said cam mounted against a follower surface and around an elongated shaft, said elongated shaft extending away from said follower surface; and
a cap within said can and engaged with said elongated shaft;
a spring having an end part seated on said cap to prevent distortion of said spring, said spring simultaneously urging said cam against said follower surface and providing a torsional force that regulates relative rotation of said cam and said follower surface.

22. The hinge of claim 21, further comprising a retaining member fixed to an opposing end of said elongated shaft to prevent axial movement of said elongated shaft and said follower surface relative to said can.

23. The hinge of claim 21, wherein said elongated shaft includes a head rotationally fixed with respect to said follower surface.
